(19) United States
(12) Patent Application Publication
(10) Pub. No.: US 2019/0363587 A1
(43) Pub. Date: Nov. 28, 2019

(54) WIRELESS CHARGING PANEL, UNIT FOR STORING ENERGY EQUIPPED WITH SAID PANEL AND CHARGEABLE ELECTRICAL SUPPLY SYSTEM

(71) Applicant: INSTITUT VEDECOM, Versailles (FR)

(72) Inventor: Friedbald KIEL, FONTAINEBLEAU (FR)

(21) Appl. No.: 16/476,830

(22) PCT Filed: Jan. 16, 2018
(86) PCT No.: PCT/FR2018/050093

§ 371 Date: Jul. 9, 2019

(30) Foreign Application Priority Data
Jan. 19, 2017 (FR) 1750408

(51) Int. Cl. H02J 50/40; H02J 50/10; H01F 38/14; H02J 7/02

(52) U.S. Cl. CPC H02J 50/40; H02J 7/025; H01F 38/14; H02J 50/10

(57) ABSTRACT

The panel comprises a plurality of spiraled active elements (11re) and is produced in a stratified form, each of the active elements comprising an active area (11AV) with a spiral-shaped active conductive strip (110). The active area is formed on a first face of the panel which is of multilayer type and comprises at least one dielectric layer and one conductive layer. Each of the active elements includes a magnetic shielding plate (112r) covering a back face of the active area. According to the invention, each of the active elements comprises a plurality of magnetic shielding strands (112) bounding the active area and connected to the magnetic shielding plate and the wireless charging panel also includes, behind the magnetic shielding plate, connecting conductive strips (110r) that are connected to the active conductive strip by conductive strands (110v) and the active conductive strip includes a plurality of connection pads (111A, 111B, 111) that are distributed over a length of the active conductive strip, the connection pads being respectively connected to the connecting conductive strips by the conductive strands.

### CROSS-REFERENCE TO RELATED APPLICATIONS

The present application is the US National Stage under 35 USC § 371 of International Application No. PCT/FR2018/050093, filed Jan. 16, 2018 which claims the priority to French application 1750408 filed on Jan. 19, 2017, the content of which (text, drawings and claims) of both applications being incorporated herein by reference.

### BACKGROUND

The invention generally relates to the field of wireless charging for electric batteries. More particularly, the invention relates to charging batteries for transport vehicles with electric traction. The invention relates to a charging panel with spiraled active elements made in laminated form. The invention also relates to an energy storage unit equipped with this panel and a chargeable electrical supply system.

The transportation industry, which is subject to very restrictive standards for pollution emissions, is undergoing true technological change with vehicle electrification. It is necessary to reduce the emissions of pollutants, such as CO₂. With the current technologies, electric and hybrid vehicles are faced with the issue of insufficient mileage autonomy when driving in electric mode due to the limited energy storage capability of the electric batteries. The weight, volume and cost of the batteries, as well as their repairability, are also major restrictive factors. The improvements made to the charging of the batteries, in terms of user comfort and charging during masked time, can be a way of compensating the limited storage capability of the batteries.

The wireless charging technique, in near field or far field, offers interesting performance, in particular in resonant coupling mode, and has the advantage of eliminating the need for a cable and power sockets to recharge the battery of the vehicle. In near field, frequencies in the range from several tens of kHz to several MHz can be used. Frequencies in the range from several hundreds of MHz to several GHz are relevant in far field.

The wireless charging technique prevents users from electrical manipulations that may sometimes present objective risks.

Furthermore, wireless charging can be considered in driving mode, when the vehicle is traveling on a roadway incorporating inductors, which would have the advantage of extending the autonomy of the vehicle with charging that is completely transparent for the user.

From US20080067874A1, it is known to associate several basic planar spiraled elements in order to form an inductor panel on a printed circuit board. The proposed device includes square spirals that allow spatial optimization and promote compactness. This device, which is provided to charge small electronic devices, such as mobile telephones, by induction, appears to be poorly suited to the high powers required in the transportation field.

US2012086394A1 describes a battery charging device of the inductive type, similar to the device disclosed in US20080067874A1, which is intended for the electric charging of small devices such as mobile telephones. The described device comprises a transmitting charging panel formed by a plurality of spiral antennas on which the devices to be charged are placed. The energy transfer is done by inductive coupling between the spiral antennas of the imaging charging panel and a charging coil integrated into the device to be charged. US2012086394A1 also discloses a receiving charging module comprising an inductive coupling circuit to which devices to be charged can be connected by wired connection. The solution described in US2012086394A1 does not lead to a satisfactory energy transfer performance and is not suitable for the electrical charging power levels required in the transportation field.

US2009096413A1 describes a variable-power inductive charging system. In this system, the spiraled elements of an inductor panel can be activated individually. The system configures itself automatically for different devices to be charged and different powers and assumes the form of a charging plate on which the device to be charged is placed.

WO2010001339A2 discloses a high-inductance planar coil that is integrated into a silicon using monolithic technology. The high inductance of this coil, obtained using front and back shielding made from a special material, allows a significant reduction in the bulk of the coil, which facilitates a monolithic integration thereof. Such a coil provided with a complete magnetic shielding is not designed to be integrated into a charging panel with inductive coupling, whether the latter is of the transmitting type or receiving type.

Wireless charging requires technological advances for large-scale deployment in the transportation field. Indeed, this technique must be optimized in order to achieve increased performance in terms of electrical resistance, electrical insulation, magnetic shielding and mechanical robustness. Furthermore, the proposed architectures and typologies must be compatible with mass production and the very restrictive costs of the automobile industry.

### SUMMARY

According to a first aspect, a wireless charging panel is disclosed which comprises a plurality of spiraled active elements, the panel being a laminated panel, each of the spiraled active elements comprising an active area with a spiral-shaped active conductive strip, the active area being formed on a first face of the panel that is a multilayer circuit comprising dielectric layers and conductive layers and each of the spiraled active elements including a magnetic shielding backplate located in a first inner layer of the multilayer circuit and covering a back face of the active area. According to an aspect of the charging panel, each of the spiraled active elements includes a plurality of first magnetic shielding strands bounding the active area and connected to the magnetic shielding backplate, and the wireless charging panel also includes, in another inner layer, behind the magnetic shielding backplate, connecting conductive strips connected to the active conductive strip by conductive strands and the active conductive strip includes a plurality of connection pads distributed over a length of the active conductive strip, the connection pads respectively being connected to the connecting conductive strips by the conductive strands.

According to one particular embodiment, the spiraled active elements are arranged in different lamination planes so as to form several planar layers of spiraled active elements, the spiraled active elements in different planar layers being aligned or offset.

According to one particular feature, the spiraled active elements are arranged in different lamination planes so as to form several planar layers of spiraled active elements, the spiraled active elements in different planar layers being aligned or offset.

According to another particular feature, each of the spiraled active elements includes a plurality of second magnetic shielding strands located at the center of the active area and connected to the magnetic shielding backplate.

According to still another particular feature, the magnetic shielding strands are formed by orifices filled with a material of high magnetic permeability extending between the active area and the magnetic shielding backplate.

According to another particular feature, the magnetic shielding backplate and the magnetic shielding strands are made from mu-metal, permalloy or an epoxy filled with a material of high magnetic permeability.

According to still another particular feature, the conductive strands are formed by orifices filled with metal extending between the connecting conductive strips and the active conductive strip.

According to still another particular feature, the conductive strips and conductive strands are made from copper.

According to still another particular feature, the spiral of the active elements is a square, rectangular or hexagonal spiral.

According to another aspect, a wireless rechargeable electric storage unit is disclosed, the unit being equipped with a charging panel as briefly described above, the panel being a receiving charging panel.

According to one particular feature, the electrical storage unit also comprises a voltage rectifying subunit, a switching subunit, an interconnection subunit and a control circuit. It will be noted that the combination of these subunits forms an energy distribution smart microgrid.

According to another specific feature, the receiving charging panel, the voltage rectifying subunit, the switching subunit, the interconnection subunit and the control circuit are formed in at least three laminated plates.

According to still another aspect, a wireless chargeable electrical supply system is disclosed. The electrical supply system comprises a wireless charging unit equipped with a charging panel as briefly described above, the panel being a transmitting charging panel, and the energy storage unit briefly described above.

According to a further aspect, a vehicle is disclosed comprising an energy storage unit as briefly described above.

### DESCRIPTION OF THE FIGURES

Other advantages and features of the claimed invention will appear more clearly upon reading the detailed description below of other specific embodiments of the invention, in reference to the appended drawings, in which:

FIG. 1 is a block diagram of a wireless chargeable electrical supply system;

FIG. 2 is an exterior perspective view of a wireless chargeable electrical storage unit;

FIG. 3 is an exterior perspective view of an electronic charging device comprising a receiving wireless charging panel;

FIG. 4 is a top view showing an active area of a spiraled active element included in the panel of FIG. 3;

FIG. 5 is a sectional view of the spiraled active element of FIG. 4;

FIG. 6 is a sectional view showing a coupling relationship of a receiving spiraled active element and a transmitting spiraled active element; and

FIG. 7 is a simplified view showing a motor vehicle equipped with a wireless rechargeable electrical storage unit.

### DETAILED DESCRIPTION

In general, to manufacture charging panels with spiraled active elements, techniques for manufacturing printed circuit boards are used that are well mastered. Thus, it is possible to use copper-clad laminate (CCL), laminated flexible or rigid plates, foils or thin metal plates typically made from copper, dielectrics pre-impregnated with resin of the epoxy type and adhesives. It is possible to use a combination of techniques comprising lamination, photolithography, screenprinting, autocatalytic deposition, electrodeposition, mechanical or laser drilling and punching.

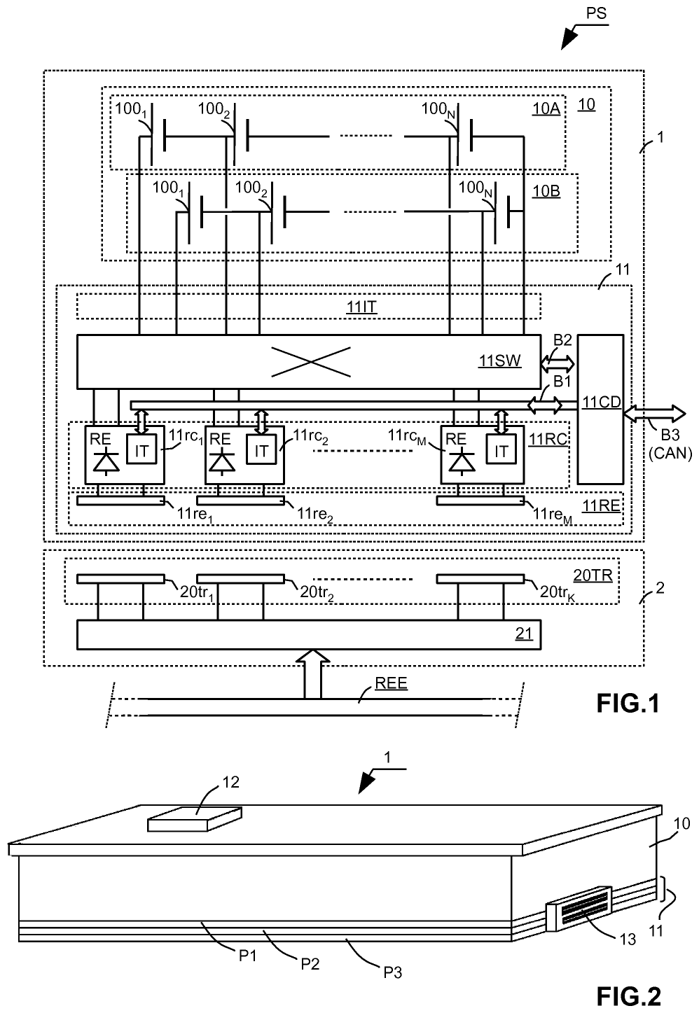

In reference to FIGS. 1 to 3, the general architecture and the operation of one particular embodiment of a wireless chargeable electrical supply system PS is first described.

As shown in FIG. 1, the electrical supply system PS comprises a wireless chargeable energy storage unit 1 and a wireless charging unit 2.

The chargeable energy storage unit 1 includes an electrical battery block 10 equipped with an electronic charging device 11. Advantageously, as shown in FIG. 2, the storage unit 1 can be made in a compact form with the charging device 11 integrated into the battery block 10, in the lower part thereof. Preferably, the storage unit 1 will be made separately to facilitate repairs and recycling.

As shown in FIG. 1, the battery block 10 is made up of a plurality of basic accumulators 100, typically of the lithium-ion type, which, depending on the applications, can assume different electrical interconnection configurations. Typically, a number N of basic accumulators or cells 100₁ to 100_{N} are mounted in series to obtain a basic battery whereof the rated voltage will preferably remain below 48 V for safety reasons. Several basic batteries 10A, 10B, . . . , can be mounted in parallel or in series to obtain the desired power or voltage. The example of FIG. 1 includes two basic batteries 10A and 10B mounted in parallel.

The charging device 11 associated with the battery block 1 comprises a receiving charging panel 11RE, a voltage rectifying subunit 11RC, a switching subunit 11SW, an interconnection subunit 11IT and a control circuit 11CD.

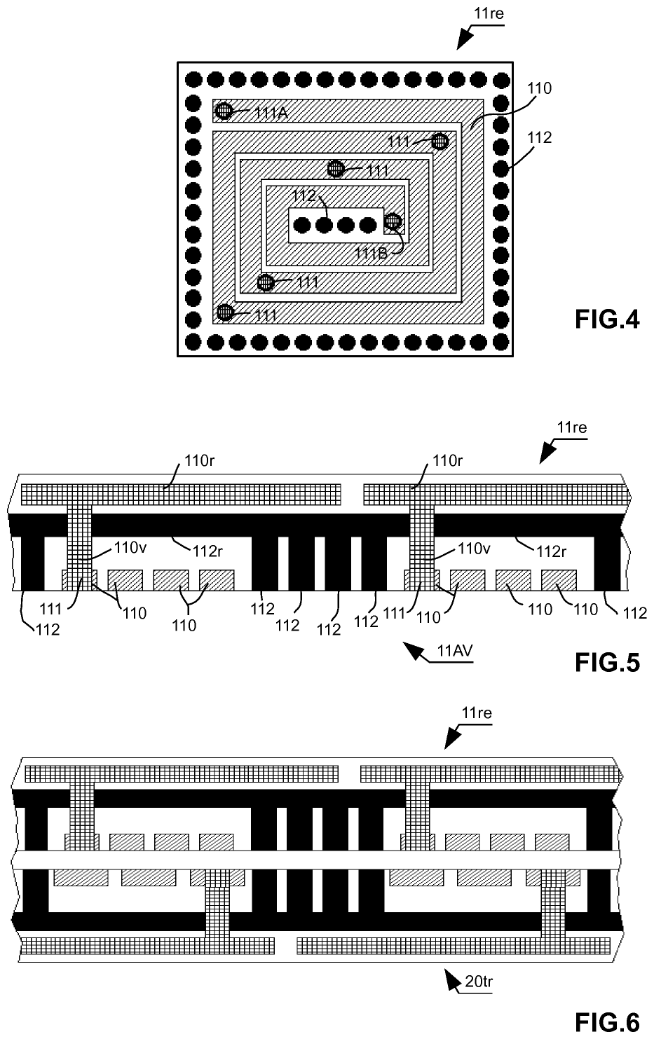

The receiving charging panel 11RE comprises a plurality of basic spiraled active elements 11re₁ to 11re_{M}, which will be described in detail hereinafter in reference to FIG. 4.

The voltage rectifying subunit 11RC comprises a plurality of rectifying circuits 11rc₁ to 11rc_{M} that are respectively connected to the plurality of basic spiraled active elements 11re₁ to 10re_{M}. The rectifying circuits 11rc are resonant circuits that are tuned to the transmitting frequency of the electrical supply system PS.

As shown in a simplified manner in FIG. 1, the rectifying circuits 11rc each comprise a rectifier RE, for example with diode or synchronous rectifying, and an interface IT with the control circuit 11CD. The interfaces IT are connected to the control circuit 11CD through a communication link B1. The interface IT allows the rectification circuit 11rc to provide the control circuit 11CD with the necessary information for the operation of the system and also allows an activation command of the rectification circuit 11rc by the control circuit 11CD. Typically, the interface IT can inform the control circuit 11CD of the operating state of the rectification circuit 11rc with which it is associated, the reception or non-reception of an alternative energy signal and the received energy level. The control circuit 11CD is thus informed of the availability, or of a potential failure, of the rectification circuit 11rc and will activate only the operational circuits 11rc that are useful for the adopted smart charging strategy. The aim is of course to minimize the electricity consumption of the system with an operation of the “standby state/active state” type.

The switching subunit 11SW is typically made with switching transistors, for example of the MOSFET type. The switching subunit 11SW serves to allow a switched electrical connection of the rectification circuits 11rc with the basic accumulators 100 of the battery block 10. The switching subunit 11SW is connected to each of the basic accumulators 100 to allow optimized individual charging of each of them. The switching subunit 11SW is connected to the control circuit 11CD by a communication link B2 and its switching is controlled by the latter. It will also be noted that means (not shown) are provided in the switching subunit 11SW to provide the control circuit 11CD with the voltage across the terminals of each of the basic accumulators 100. The voltages supplied to the control circuit 11CD inform the latter of the charging state of each of the basic accumulators 100.

The switching subunit 11SW is commanded by the control circuit 11CD so as to obtain a desired electrical connection configuration of the rectification circuits 11rc on the basic accumulators 100. This electrical connection configuration is determined by the control circuit 11CD based on the charging strategy and information that it has on the charging state of the accumulators and on the reception of the alternative energy signals by the rectification circuits 11rc.

The interconnection subassembly 11IT will take different forms depending on the application and the internal connection configuration of the battery block 10. The embodiment 1 described here of the system includes individual connections to each of the basic accumulators 100. In other embodiments, the basic accumulators 100 will not be managed individually by the control circuit 11CD, but collectively by group, and the interconnection subunit 11IT will comprise busbars to which the different basic accumulators 100 of a same group will be connected.

The control circuit 11CD is typically formed by a microprocessor controller comprising a processing unit, working and storage memories, and input/output interfaces. The input/output interfaces are connected to the communication links B1/B2, and to a communication link B3, for example, with an ADC bus of the vehicle equipped with the storage unit 1.

As shown in FIG. 1, the wireless charging unit 2 comprises a transmitting charging panel 20TR and electrical supply subunit 21. The electrical supply subunit 21 supplies the panel 20TR with an alternating supply voltage having a frequency IF. The transmitting charging panel 20TR has an architecture similar to that of the receiving charging panel 11RE and comprises a plurality of basic spiraled active elements 20tr₁ to 20tr_{K}.

In this embodiment, the electrical supply subunit 21 is connected to an electrical distribution network REE, called primary network. In the context of applications to motor vehicles, the electrical distribution network REE will preferably be buried in the ground. The electrical supply subunit 21 will be installed flush with the driving surface. In the case of a charging installation for a parked vehicle, the wireless charging unit 2 can be mounted on a lift to better couple the transmitting charging panel 20TR and the receiving charging panel 11RE and to maximize the performance of the energy transfer.

In this embodiment, the electrical supply subunit 21 includes an AC/DC rectifying device (not shown) and a plurality of DC/AC converters (not shown) that respectively supply the plurality of basic spiraled active elements 20tr₁ to 20tr_{K} at the frequency IF. Means for detecting the presence of an energy storage unit 1 above the transmitting charging panel 20TR will also be provided, as well as activation means, on command instruction, for the transfer of energy by the wireless charging unit 2. The energy transfer can be fully automated and will include the verification of safety conditions.

A simplified exterior view of the energy storage unit 1 is shown in FIG. 2. As shown in this figure, the electronic charging device 11 is mounted on a lower face of the battery block 10. The battery block 10 typically has dimensions of 100 cm×200 cm×20 cm. A power terminal 12 and an electrical connector 13 are present on other faces of the battery block 10. The power terminal 12 allows a connection of the unit 1 to a DC electrical power network, called secondary network. The electrical connector 13, in the case of an application to a motor vehicle, allows a connection of the electronic charging device 11 to a digital control network, for example of the ADC type, and a low-voltage network of the vehicle.

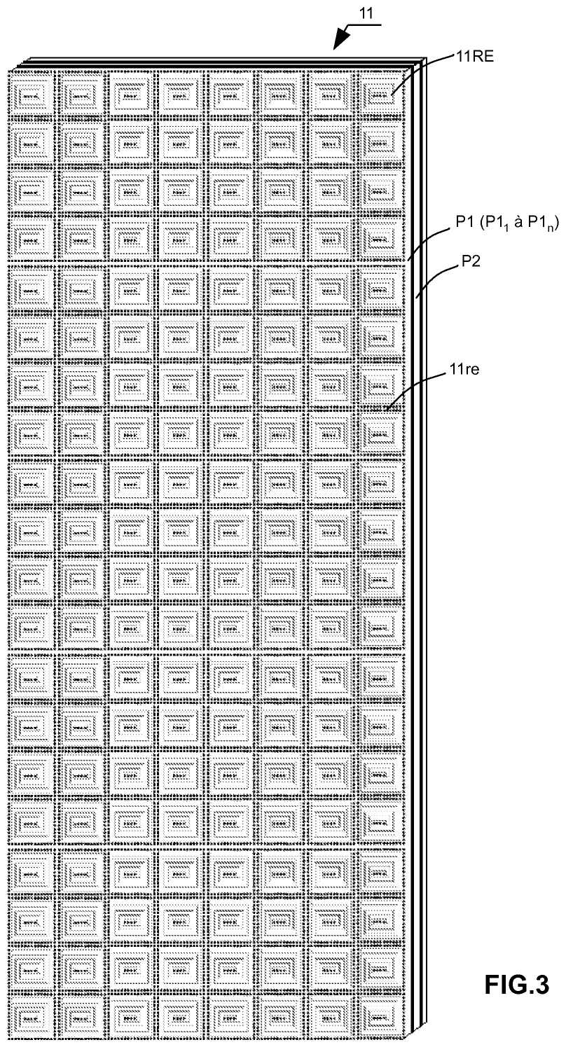

Also in reference to FIG. 3, in this embodiment, the electronic charging device 11 is made in the form of a lamination of several printed circuit plates P1, P2 and P3.

Of course, in other embodiments, there can be more than three laminated plates. Furthermore, the plates are not necessarily made in the form of a printed circuit board, but can be obtained by related technologies using lamination.

The plates P1, P2 and P3 here are rectangular and all have dimensions, typically 200 cm×100 cm, equal to those of the lower face of the battery block 10, as shown in FIG. 2. The plates P1, P2 and P3 typically have thicknesses of 1 mm, 4 mm and 3 mm, respectively.

The plate P1 includes the receiving charging panel 11RE in the first interconnection layer. In this embodiment, the panel 11RE of FIG. 3 comprises twenty rows of eight spiraled active elements 11re.

In another particular embodiment allowing increased performance levels, the plate P1 will comprise several planar layers P1₁ to P1ₙ of spiraled active elements 11re. The spiraled active elements here are distributed in different lamination planes and will, depending on the application, be aligned or offset between successive planar layers Pₙ₋₁, Pₙ.

The plate P2 includes a second interconnection layer, the voltage rectification subunit 11RC and the control circuit 11CD.

The plate P3 includes the switching subunit 11SW and the interconnection assembly 11IT.

In reference to FIGS. 4 and 5, we will now describe the typology of a spiraled active element 11re of the receiving charging panel 11RE.

It will be noted that the general typology of the spiraled active element 20tr of the transmitting charging panel 20TR is similar to that of the spiraled active element 11re. However, the transformation ratio between the spiraled active elements 11re and 20tr, which is equal to the ratio of the respective numbers of turns of the elements, is not imposed in the system and can be chosen for an adaptation with the charging strategy of the battery block 10 and the primary electrical distribution network REE.

As shown in FIGS. 4 and 5, the spiraled active element 11re is made in the form of a multilayer printed circuit board and essentially comprises an active conductive strip 110 made in a square spiral, a plurality of connection pads 111A, 111B, 111, a plurality of magnetic shielding strands 112, a buried magnetic shielding backplate 112r and strands 110v and connecting conductive strips 110r.

The printed circuit board is of a conventional type, for example FR4, on a resin substrate of the epoxy type reinforced by a fiberglass fabric.

According to this embodiment, the spiral of the active element 11re is a square spiral. According to another embodiment, the spiral of the active element 11re is a rectangular or hexagonal spiral. Typically, the active element 11re has dimensions of 5 cm×5 cm in its square shape or of 5 cm×10 cm in its rectangular shape.

The conductive strip 110 is made from copper and is made on an active front area 11AV of the spiral active element 11re.

As shown in FIG. 4, the connection pads 111 are distributed over the length of the conductive strip 110 between two end connection pads 111A and 111B at the two ends of the spiral. These different connection pads allow the choice of the number of turns of the spiraled active element 11re. Each connection pad 111A, 111B, 111 is connected to a respective buried connection strip 110r by means of a connecting conductive strand 110v formed by an orifice filled with copper.

The magnetic shielding material making up the strands 112 and the plate 112r has a high magnetic permeability. Typically, this magnetic shielding material is mu-metal, permalloy or an epoxy filled with a material of high magnetic permeability. The strands 112 are all connected to the buried magnetic shielding backplate 112r. The buried plate 112r is located on an inner layer partway between the spiral conducting strip 110 and the buried connecting strips 110r and forms a back shielding of the active element 11re. The strands 112 are formed by orifices filled with material with a high magnetic permeability between the buried plate 112r and the active area 11AV.

First strands 112 are distributed in a square on the perimeter of the spiraled active element 11re. Second strands 112 are aligned and located at the center of the spiral.

As shown clearly in FIG. 5, the strands 112 and the buried plate 112r form a shielding of high magnetic permeability that channels the magnetic field lines toward the active front area 11AV of the spiraled active element 11re.

FIG. 6 shows a receiving spiraled active element 11re in an optimal magnetic coupling relationship with a transmitting spiraled active element 20tr. The elements 11re and 20tr are brought closer together and their active conducting strips are positioned perfectly opposite one another. In such a configuration, the energy transmission is maximal between the two elements.

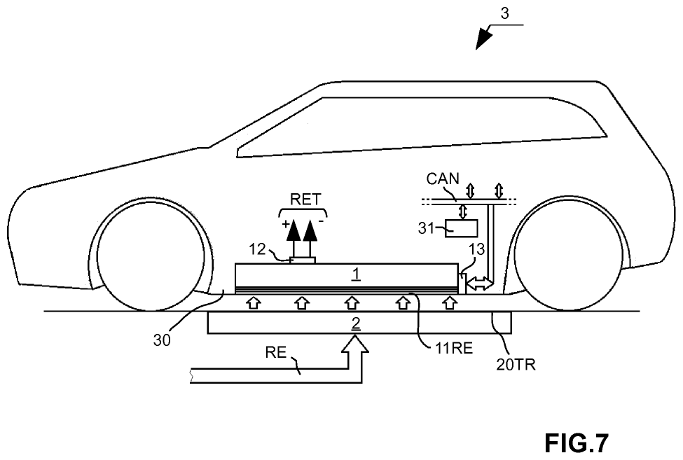

As shown in FIG. 7, in an application to a motor vehicle 3, the energy storage unit 1 is preferably installed in the floor 30 of the vehicle, with the electronic charging device 11 and the receiving charging panel 11RE oriented toward the ground. The wireless charging unit 2 is placed in the ground, or in the driving roadway of the vehicle, is powered by the electrical distribution network REE, and is able to transfer energy to the unit 1 when determined conditions are met. As also shown in FIG. 7, the unit 1 is connected to an electric traction network RET of the vehicle through its power terminal 12 and to the ADC bus of the vehicle through its connector 13. A battery management system 31 of the vehicle is in communication with the command circuit 11CD of the unit 1 through the ADC bus and participates in the management of the unit 1.

The claimed invention is not limited to the specific exemplary embodiments described above. One skilled in the art, depending on the applications, can provide various changes and variations that fall within the scope of the appended claims.

1. A wireless charging panel comprising a plurality of spiraled active elements, said panel being a laminated panel, each of said spiraled active elements comprising an active area with a spiral-shaped active conductive strip, said active area being formed on a first face of said panel that is a multilayer circuit comprising dielectric layers and conductive layers and each of said spiraled active elements including a magnetic shielding backplate located in a first inner layer of said multilayer circuit and covering a back face of the active area, wherein each of said spiraled active elements includes a plurality of first magnetic shielding strands bounding said active area and connected to the magnetic shielding backplate, and wherein the panel also includes, in an inner layer behind said magnetic shielding backplate, connecting conductive strips connected to said active conductive strip by conductive strands and said active conductive strip includes a plurality of connection pads distributed over a length of said active conductive strip, said connection pads respectively being connected to said connecting conductive strips by said conductive strands.

2. The charging panel according to claim 1, wherein said spiraled active elements are arranged in different lamination planes so as to form several planar layers of spiraled active elements, said spiraled active elements in different planar layers being aligned or offset.

3. The charging panel according to claim 1, wherein each of said spiraled active elements includes a plurality of second magnetic shielding strands located at the center of said active area and connected to the magnetic shielding backplate.

4. The charging panel according to claim 1, wherein said magnetic shielding strands are formed by orifices filled with a material of high magnetic permeability extending between said active area and said magnetic shielding backplate.

5. The charging panel according to claim 1, wherein said magnetic shielding backplate and said magnetic shielding strands are made from mu-metal, permalloy, or an epoxy filled with a material of high magnetic permeability.

6. The charging panel according to claim 1, wherein said conductive strands are formed by orifices filled with metal extending between the connecting conductive strips and the active conductive strip.

7. The charging panel according to claim 1, wherein said conductive strips, and conductive strands are made from copper.

8. The charging panel according to claim 1, wherein said spiral of the active elements define a square, rectangular or hexagonal spiral.

9. A wireless rechargeable electric storage unit equipped with a charging panel according to claim 1, said panel being a receiving charging panel.

10. The electrical storage unit according to claim 9, wherein said electrical storage unit also comprises a voltage rectifying subunit, a switching subunit, an interconnection subunit and a control circuit.

11. The electrical storage unit according to claim 10, wherein said receiving charging panel, voltage rectifying subunit, switching subunit, interconnection subunit and control circuit are formed in at least three laminated plates.

12. A wireless chargeable electrical supply system comprising a wireless charging unit having a transmitting charging panel, and an energy storage unit having a receiving charging panel; said transmitting charging panel and said receiving charging panels each being a charging panel according to claim 1.

13. A vehicle, characterized in that it comprises an energy storage unit according to claim 9.
